(19) United States
(12) Patent Application Publication
(10) Pub. No.: US 2014/0108266 A1
(43) Pub. Date: Apr. 17, 2014

(54) Process for the electronic negotiation of a binding agreement

(71) Applicant: G. Gregory DAWE, Gloucester, MA (US)

(72) Inventor: G. Gregory DAWE, Gloucester, MA (US)

(21) Appl. No.: 13/573,975

(22) Filed: Oct. 17, 2012

(51) Int. Cl. G06Q 50/18; G06Q 30/00

(52) U.S. Cl. CPC G06Q 50/188; G06Q 30/00
USPC 705/80

(57) ABSTRACT

A process for the electronic negotiation that enables two or more Parties to negotiate the terms of a binding agreement. The process for the electronic negotiation of a binding agreement generally includes a Computer Server 10 and a Software Element 20.

### BACKGROUND OF THE INVENTION

The present invention relates generally to negotiations and more specifically it relates to a process for the electronic negotiation of a binding agreement to electronically enable two or more Parties to negotiate the terms of a binding agreement and is based upon my Provisional Patent Application 61/628,040, filed 21 Oct. 2011, and incorporated herein by reference, in its entirety.

### BRIEF SUMMARY OF THE INVENTION

The invention generally relates to a negotiation which includes a Computer Server 10 and a Software Element 20.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a process for the electronic negotiation of a binding agreement that electronically enables two or more Parties to negotiate the terms of a binding agreement.

Another object is to provide a Process for the Electronic Negotiation of a Binding Agreement that provides methods for initiating an electronic negotiation, methods for advancing progress towards reaching an agreement, and methods for concluding or terminating the electronic negotiation of an agreement.

Another object is to provide a Process for the Electronic Negotiation of a Binding Agreement that protects the activities of the Parties, the artifacts of the negotiation, and the resulting agreement from disclosure to non-Parties.

Another object is to provide a Process for the Electronic Negotiation of a Binding Agreement that provides the Parties with an irrefutable record of the negotiation and an authoritative source of the artifacts of the negotiation and resulting agreement.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1: FIG. 1 is a block diagram illustrating a sub-component of the present invention. FIG. 1 illustrates the main elements and sub-elements.

FIG. 2: FIG. 2 is a flowchart illustrating the overall operation of the present invention. FIG. 2 depicts the progression of stages in the electronic negotiation process.

FIG. 3: FIG. 3 is a flowchart illustrating a sub-operation of the present invention. FIG. 3 illustrates the main steps of the Content Consensus Stage of the electronic negotiation process.

FIG. 4: FIG. 4 is a flowchart illustrating a sub-operation of the present invention. FIG. 4 illustrates the main steps of the Signing Consensus Stage of the electronic negotiation process.

### DETAILED DESCRIPTION OF THE INVENTION

### A. Overview

Turning now descriptively to the drawings, in which similar reference characters denote similar elements throughout the several views, the figures illustrate a Computer Server 10 and a Software Element 20.

### B. Computer Server

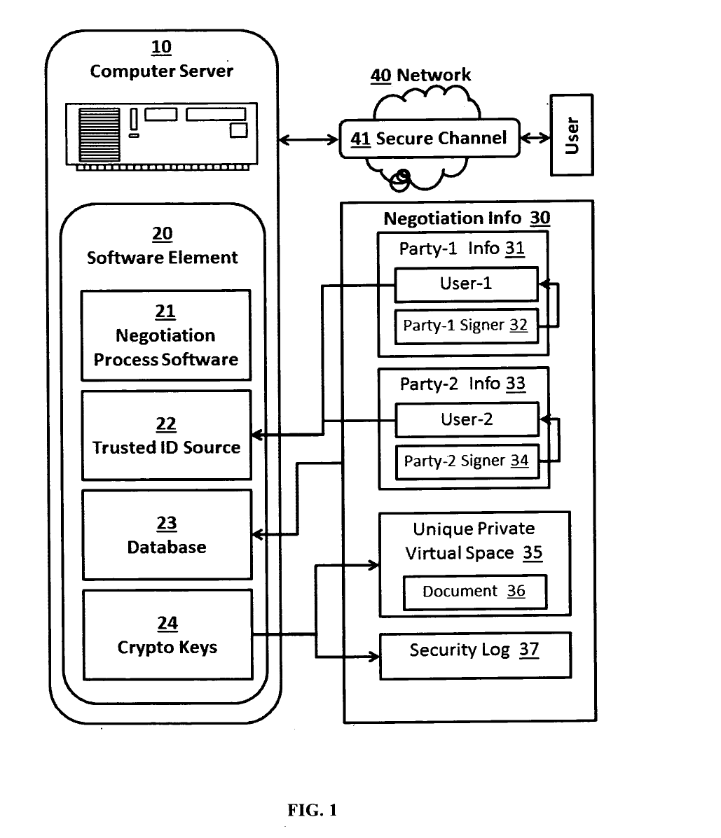

The Computer Server 10 is attached to a Network (See FIG. 1). A function of the Computer Server 10 is to host and execute the Software Element 20. Another function of the Computer Server 10 is to provide storage for information used within the Software Element 20. Another function of the Computer Server 10 is to provide the computational resources necessary to perform the digital protections that ensure the privacy and integrity of the electronic negotiation process. Another function of the Computer Server 10 is to provide network connectivity between the Software Element 20 and users involved in electronic negotiations.

The Computer Server 10 can be a commercially available system with processor, storage system, and network adaptor capable of serving the demands placed by the Users on the Software Element 20.

The Computer Server 10 may be implemented in physical machines, virtual machines, using Cloud computing resources, or in combinations. The extent and methods of access controls and other secure hosting arrangements provided by the Computer Server 10 will vary with the operating system and security environment. The network can be a publicly accessible network, such as the Internet, a private network, or a hybrid.

### C. Software Element

The Software Element 20 is comprised of the Negotiation Process software sub-element 21, a Trusted Identity Source sub-element 22, a Database sub-element 23, and a Crypto Keys sub-element 24. A function of the Software Element 20 is to provide mechanisms for initiating, conducting, and concluding or terminating participation in an electronic negotiation, including mechanisms that regulate the order of activities in an electronic negotiation. Another function of the Software Element 20 is to protect the activities of the Parties, the artifacts of the negotiation, and the resulting agreement from disclosure to non-Parties. Another function of the Software Element 20 is to provide an irrefutable record of an electronic negotiation and an authoritative source of the artifacts of the negotiation and any resulting agreement.

The Negotiation Process Software sub-element 21 implements all objects of this invention. The Trusted Identity Source sub-element 22, Database sub-element 23, Crypto Keys sub-element 24, and Computer Server 10 (see FIG. 1) provide mechanisms and resources necessary to the mechanisms of the Negotiation Process Software sub-element 21.

Users initiate and conduct electronic negotiations with each other by interacting with the mechanisms of the Negotiation Process Software sub-element 21. Interactions between a User and the Negotiation Process Software sub-element 21 occur over a Network 40 in a Secure Channel 41 that protects these interactions from disclosure to non-Parties. The Negotiation Process Software sub-element 21 uses the resources of the Identity Source sub-element 22 to authenticate the User prior to interaction. An authenticated User may interact with the mechanisms of the Negotiation Process Software sub-element 21 to participate in electronic negotiation activities in which they are a Party, to un-enroll from an electronic negotiation in which they are a Party, and to initiate new electronic negotiations.

The Negotiation Process Software sub-element 21 uses the resources of the Database sub-element 23 to construct and maintain a unique instance of Negotiation Info 30 that contains information describing the Parties and Users participating in an electronic negotiation. The Negotiation Process Software sub-element 21 uses the resources of the Trusted Identity Source sub-element 22 in conjunction with the Negotiation Info 30 to prevent access to an electronic negotiation by a User not associated with a Party in the electronic negotiation. The Negotiation Process Software sub-element 21 uses the resources of the Crypto Keys sub-element 24 to protect the contents of Negotiation Info 30 from disclosure to non-Parties.

The Negotiation Process Software sub-element 21 uses the resources of the Database sub-element 23 to create and maintain a unique private virtual space 35 for each electronic negotiation, and to maintain an association between the unique private virtual space 35 and the corresponding Negotiation Info 30. The unique private virtual space 35 is used to store documents and other content containing the terms of the negotiation, and to store information describing and related to user-proposed changes to these documents. The Negotiation Process Software sub-element 21 uses the Crypto Keys sub-element 24 to protect the information in the unique, private, virtual space from disclosure to non-Parties.

The Negotiation Process Software sub-element 21 uses the resources of the Database sub-element 23 to create and maintain a Security Log 37 that records events and activities that occur during an electronic negotiation. The Negotiation Process Software sub-element 21 uses the Crypto Keys sub-element 24 to protect the authenticity of the contents of the Security Log 37 and to protect events described in the Security Log 37 from repudiation by the users involved in the events. The Negotiation Process Software sub-element 21 uses the Crypto Keys sub-element 24 to protect the contents of the Security Log 37 from disclosure to non-Parties.

The Negotiation Process Software sub-element 21 contains mechanisms that implement four roles within the electronic negotiation process.
Initiating User.
Enrolled User.
Signing User.
Administrator.

An initiating user is any user that interacts with the mechanisms of the Electronic Negotiation Process Software sub-element 21 that create a new electronic negotiation. These mechanisms allow an initiating user to identify and issue secure invitations to other users to join the new electronic negotiation. These other users may use their secure invitations to interact with the Electronic Negotiation Process Software sub-element 21 and enter a registration process that, once passed, allows these other users to participate in the electronic negotiation. Enrolled users are the users that successfully complete the registration process.

The roles of the initiating user and enrolled users differ in three main ways. There is only one initiating user per electronic negotiation, while there may be more than one enrolled user per electronic negotiation. The initiating user instigates an electronic negotiation, whereas an enrolled user is the result of a completed response to an invitation to join an electronic negotiation. The initiating user cannot un-enroll from an electronic negotiation, whereas an enrolled user may un-enroll from an electronic negotiation as long as no member of the enrolled user's Party has signed the documents contained in the unique private virtual space 35.

A signing user is any user participating in an electronic negotiation (initiating or enrolled) who has asserted to the Negotiation Process Software sub-element 21 that they are authorized to sign on behalf of their Party. A non-signing user may assert their authorization to sign on behalf of their Party (and therefore become a signing user) to the mechanisms of the Negotiation Process Software sub-element 21 at any point until a member of their Party has signed.

The role of the administrator differs significantly from the initiating, enrolled, and signing users. The administrator's principal functions are to manage the user identities in the Trusted Identity Source sub-element 22 and to manage the security and operational policies of the Negotiation Process Software sub-element 21. The administrator has no view into, or ability to participate in an electronic negotiation, nor any view into, or ability to acquire documents or other information related to an electronic negotiation.

The Negotiation Process Software sub-element 21 contains mechanisms that implement a six-stage process that guides and regulates user activities during an electronic negotiation.

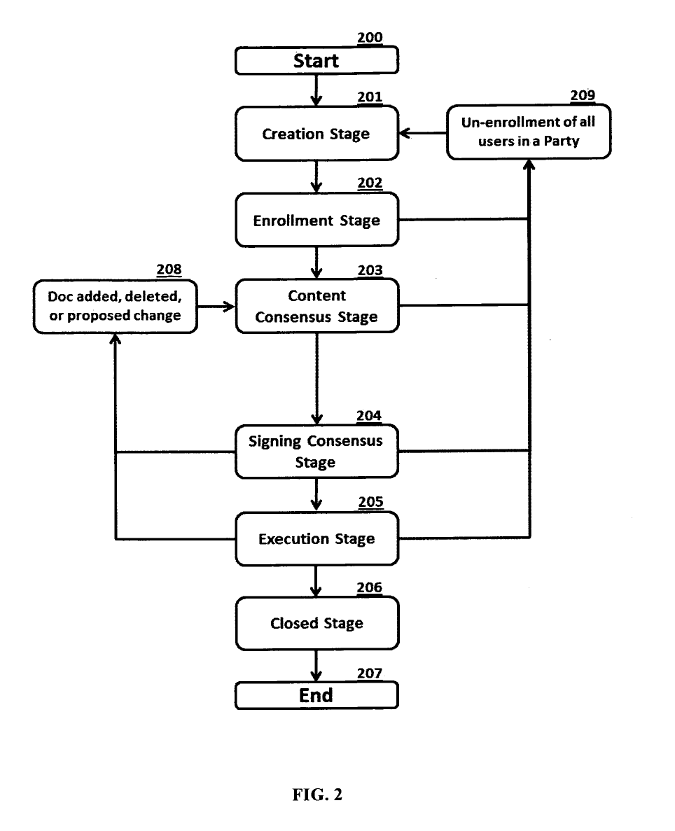

Referring to FIG. 2, the stages of the electronic negotiation process are:

1. Creation Stage 201.

2. Enrollment Stage 202.

3. Content Consensus Stage 203.

4. Signing Consensus Stage 204.

5. Execution Stage 205.

6. Closed Stage 206.

Progression through the six stages is sequential, beginning at the Creation Stage 201 and is initiated and driven by the actions of the Parties, as represented by the participating users. Mechanisms of the Negotiation Process Software sub-element 21 keep all participating users informed of events and the actions of the Parties throughout the electronic negotiation process. Progression requirements are cumulative, meaning that the Parties must collectively satisfy the completion requirements of the current stage and maintain the requirements of prior stages before progressing to a higher stage. Actions by a user that undo the requirements of an earlier stage will cause the process to regress to the stage that mandates the undone requirement. A binding agreement is constructed when the Parties complete all six stages of the electronic negotiation process.

The Creation Stage 201 and Enrollment Stage 202 bring the Parties together at the start of the electronic negotiation. The Content Consensus Stage 203 provides the Parties with mechanisms to add documents to the unique private virtual space 35, and mechanisms for the Parties to reach agreement on the terms in those documents. The Signing Consensus Stage 204 provides the Parties with mechanisms to indicate their readiness to sign the agreement represented by the documents contained in the unique private virtual space 35. The Execution Stage 205 provides the Parties with mechanisms to sign the documents contained in the unique private virtual space 35 and contains mechanisms to protect the contents of unique private virtual space 35 after all Parties have signed. The Closed Stage 206 provides the Parties with mechanisms to obtain signed copies of the documents and information for reviewing events that occurred during the electronic negotiation.

The Negotiation Process Software sub-element 21 regulates progression through the stages of the electronic negotiation process.

To progress from the Creation Stage 201 to the Enrollment stage 202 the initiating user must have identified at least two Parties to the Negotiation Process Software sub-element 21, identified and associated at least one unique user with each Party, the Negotiation Process Software sub-element 21 must have constructed a unique instance of Negotiation Info 30 and recorded the user and Party information provided by the initiating user, the Negotiation Process Software sub-element 21 must have constructed a unique private virtual space 35 and associated it with the Negotiation Info 30, and the Negotiation Process Software sub-element 21 must have issued secure invitations to join the electronic negotiation to the users other than the initiating user.

To progress from the Enrollment Stage 202 to the Content Consensus Stage 203 users issued secure invitations by the Negotiation Process Software sub-element 21 in the prior stage must have used their respective invitations to register their participation in the electronic negotiation with the Negotiation Process Software sub-element 21, such that each Party is represented by at least one user (initiating or enrolled).

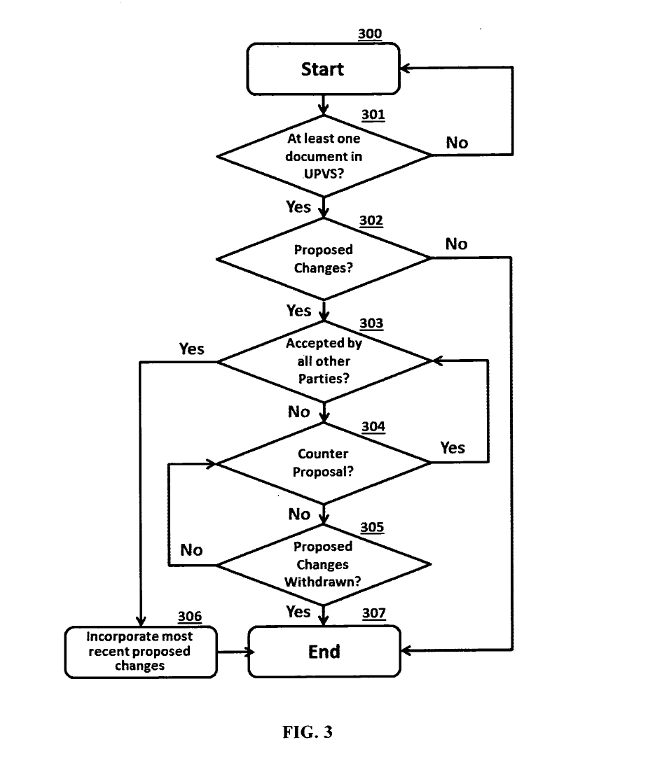

To progress from the Content Consensus Stage 203 to the Signing Consensus Stage 204 at least one document 36 must reside in the unique private virtual space 35 associated with the electronic negotiation, and there must be no active proposed changes to the documents in the unique private virtual space 35. Referring to FIG. 3, a proposed change to a document ceases to be active if it is either withdrawn 305 by the proposing user or is accepted by at least one user from each of the other Parties 303. Proposed changes that are accepted by at least one user from each the other Parties 303 are automatically incorporated 306 into the document.

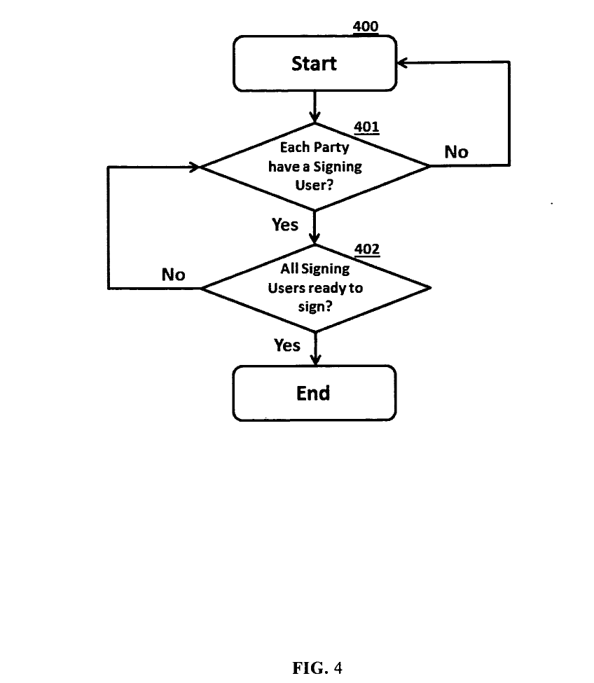

Referring to FIG. 4, to progress from the Signing Consensus Stage 204 to the Execution Stage 205 there must be at least one signing user per Party 401 and all signing users must concurrently maintain their readiness to sign 402 the documents residing in the unique private virtual space 35.

To progress from the Execution Stage 205 to the Closed Stage 206 all signing users from all Parties in the electronic negotiation must have signed the documents residing in the unique private virtual space 35.

For the Closed Stage 206 to successfully terminate, the artifacts of the electronic negotiation process, including the signed documents must be made available to the Parties.

The Negotiation Process Software sub-element 21 regulates regression from higher to lower stages in the electronic negotiation process.

A User that is a member of a Party that has not signed the documents 36 contained in the unique private virtual space 35 may un-enroll from an electronic negotiation, and thereby become a non-Party. If all users of a Party un-enroll the electronic negotiation process reverts to the Creation Stage 201.

Up to the point when the initiating user's Party has signed, the initiating user may use the mechanisms of the Negotiation Process Software sub-element 21 to identify new Parties, to invite additional users, and to associate those users with any of the Parties in the electronic negotiation. If the initiating user identifies a new Party the electronic negotiation process reverts to the Enrollment Stage 202.

A User that is a member of a Party that has not signed the documents 36 contained in the unique private virtual space 35 may add or remove documents 36 from the unique private virtual space 35, or propose changes to existing documents 36. When this occurs during the Signing Consensus Stage 204 or Execution Stage 205 the electronic negotiation process reverts to the Content Consensus Stage 203.

A signing user that is a member of a Party that has not signed the documents 36 contained in the unique private virtual space 35 may un-enroll from the electronic negotiation. If the former signing user's Party contains other users, but no other signing users the electronic negotiation process reverts to the Signing Consensus Stage 204.

The Software Element 20 can be built using commercially available application technology platforms. The Negotiation Process Software sub-element 21 may be constructed to interoperate with users via the web, via mobile networks, through combinations of these mediums, and via future mediums. The Software Element 20 may be logically divided and installed across an array of instances of the Computer Server 10 as a means of improving performance, scalability, ease of maintenance, security, or other attributes. The Crypto Keys sub-element 24 may reside on the Computer Server 10 or on trusted external devices. The type of protection implemented by the Negotiation Process Software sub-element 21 in conjunction with the Crypto Keys sub-element 24 may vary as a means of improving security or other attributes. The selection of the version and type of Database sub-element 23 can vary as a means of improving performance, scalability, security, and other attributes. The contents of the Database sub-element 23 may be logically divided and implemented across multiple instances of the Database sub-element 23 as a means of improving performance, scalability, security, or other attributes. The Trusted Identity Source sub-element 22 may connect to a Directory Service, Authentication Service, or other Identity Management System that may or may not reside on the Computer Server 10.

The following are functional variations of the electronic negotiation process:
The Creation Stage 201 of the electronic negotiation process may be configured to allow the initiating user to add documents to the electronic negotiation prior to the onset of the Content Consensus Stage 203.
The electronic negotiation process may be configured to allow enrolled users to invite other users to become members of the enrolled user's Party. When so configured, these invitations may only be sent by enrolled users associated with a Party that has not yet signed, and their issuance will not cause the electronic negotiation process to revert to the Enrollment Stage 202.
The Content Consensus Stage 203 of the electronic negotiation process may be configured to restrict the number of documents that can be added to an electronic negotiation to a configurable maximum number.
The Content Consensus Stage 203 of the electronic negotiation process may be configured to restrict the users that are allowed to add documents to an electronic negotiation. For example, adding documents could be restricted to the initiating user, or to members of one Party, such as the Party that the initiating user is a member of, or based on other policies.
The Content Consensus Stage 203 of the electronic negotiation process may be configured to restrict the types of documents that can be added to an electronic negotiation.
The Content Consensus Stage 203 of the electronic negotiation process may be configured to restrict the users who can propose changes to a document. For example, proposing changes could be restricted to the initiating user, restricted to members of one Party, such as the Party that the initiating user is a member of, or restricted based on other policies.
The Content Consensus Stage 203 of the electronic negotiation process may be configured to restrict the extent or scope of changes that can be proposed for a specific document. For example, proposed changes could be restricted to certain sections of a document, or restricted from certain sections of a document.
The Content Consensus Stage 203 of the electronic negotiation process may be configured to allow users to propose changes to an active proposed change (i. E a counter proposal) to a document. Referring to FIG. 2, in such situations the counter proposal 304 must be accepted by all other Parties 303 before it is incorporated into the document 306. Counter proposals to a proposed change can continue for as long as practical until they are either accepted by all other Parties 303 or the proposed change on which the chain of counter proposals is based is withdrawn 305 by the user who proposed it.
The Content Consensus Stage 203 of the electronic negotiation process may be configured to allow users to accept portions of an existing proposed change to a document. In such situations an accepted portion must accepted by all other Parties before the accepted portion is incorporated into the document, after which the portion is removed from the proposed change.
The Content Consensus Stage 203 of the electronic negotiation process may be configured to allow users to propose a change that involves more than one document.
The Content Consensus Stage 203 of the electronic negotiation process may be configured to require that a proposed change to a document be unanimously accepted by all users associated with the other Parties (rather than just one user) before it is incorporated into the document.
The Content Consensus Stage 203 of the electronic negotiation process may be configured to allow users to add expiration conditions to a proposed change that cause the proposed change to be automatically withdrawn if it has not been accepted by all other Parties by a specified date and time period.
The Signing Consensus Stage 204 of the electronic negotiation process may be configured to disallow the addition or deletion of documents.
The Execution Stage 205 of the electronic negotiation process may be configured to disallow proposed changes to documents, or the addition or deletion of documents.
Expiration conditions that automatically void an electronic negotiation if it has not successfully completed by a certain date and time, or within a certain time period, may be configured.

### D. Connections of Main Elements and Sub-Elements of Invention

The Software Element 20 is installed on the Computer Server 10. Mechanisms of the Negotiation Process Software sub-element 21 use mechanisms of the Trusted Identity Source sub-element 22 to authenticate and authorize users involved in electronic negotiation activities. The mechanisms of the Negotiation Process Software sub-element 21 use the mechanisms of the Trusted Identity Source sub-element 22 to catalogue and maintain user identity information and credentials. The mechanisms of the Negotiation Process Software sub-element 21 use the mechanisms and resources of the Database sub-element 23 to store information related to electronic negotiations and resulting agreements. The mechanisms of the Negotiation Process Software sub-element 21 use the mechanisms and resources of the Crypto Keys sub-element 24 to digitally protect information stored in the Database sub-element from disclosure to non-Parties. The mechanisms of the Negotiation Process Software sub-element 21 use the mechanisms and resources of the Crypto Keys sub-element 24 to digitally protect the event and activity information recorded in the Security Log 37.

### E. Alternative Embodiments of Invention

The electronic negotiation process may be configured to allow users to change the documents in an electronic negotiation directly, without requiring the acceptance of the changes by the other Parties. In this alternative variation, if the electronic negotiation process is at or above the Signing Consensus Stage 204 it will regress to the Content Consensus Stage 203 if a user from a Party that has not signed makes a change to a document in, adds a new document to, or deletes a document from the unique private virtual space 35.

### F. Operation of Preferred Embodiment

The following example describes a simple electronic negotiation in which two different companies negotiate the terms of a business transaction. The first company, called Party-1, acts as the seller, while the second company, called Party-2 acts as the buyer. Party-1's standard purchasing terms are the starting point for the electronic negotiation. Both companies have designated persons acting on their behalf in the negotiation. User-1 will represent Party-1 and User-2 will represent Party-2. Throughout this example both users are assumed to have been connected to the Negotiation Process Software sub-element 21 via secure channel and been authenticated using the mechanisms of the Trusted Identity Source 22 prior to their activity.

User-1 interacted with the mechanisms of Negotiation Process Software sub-element 21 that create new electronic negotiations. Responding to prompts for information from the Negotiation Process Software sub-element 21 User-1 provided information describing the new electronic negotiation, including information 31 describing Party-1 and information 33 describing Party-2. User-1 associated himself with Party-1 and identified himself 32 as a signing user on behalf of Party-1. Using the facilities of the Trusted Identity Source 22 User-1 identified User-2 and associated User-2 with the information 33 describing Party-2. Using the resources of the Database sub-element 23, the Negotiation Process Software sub-element 21 catalogued this information in a new instance of Negotiation Info 30, constructed a unique private virtual space 35, associated the unique private virtual space 35 with the Negotiation Info 30, issued a secure invitation to User-2 to join the electronic negotiation, and recorded these events in the Security Log 37. The Negotiation Process Software sub-element 21 calculated that the requirements for advancing to the Enrollment Stage 202 were met.

User-2 received and acted on the secure invitation to join the electronic negotiation. Responding to prompts for information from the Negotiation Process Software sub-element 21 User-2 confirmed his association with Party-2, identified himself 34 as a signing user on behalf of Party-2, and completed the registration in the electronic negotiation. The Negotiation Process Software sub-element 21 recorded these events in the Security Log 37 and notified all Parties in the electronic negotiation that User-2 joined. The Negotiation Process Software sub-element 21 calculated that the requirements for advancing to the Content Consensus Stage 203 were met.

After receiving the notification that User-2 joined the electronic negotiation User-1 added a document 36 containing Party-1's standard purchasing terms to the unique private virtual space 35. The Negotiation Process Software sub-element 21 recorded these events in the Security Log 37 and notified all Parties of the new document 36.

Upon receiving the notification about the newly added document 36, User-2 viewed the document 36 and proposed a change to the terms. The Negotiation Process Software sub-element 21 recorded these events in the Security Log 37 and notified all Parties of the proposed change to the document 36.

After being notified about User-2's proposed change to the terms, User-1 read User-2's proposed change to the terms, and then accepted User-2's proposed change to the terms. The Negotiation Process Software sub-element 21 calculated that User-2's proposed change had been accepted by all other Parties and incorporated the proposed change into the document 36. The Negotiation Process Software sub-element 21 recorded these events in the Security Log 37 and notified all Parties of the accepted change to the document 36. The Negotiation Process Software sub-element 21 calculated that the requirements for advancing to the Signing Consensus Stage 204 were met and notified all Parties of the opportunity to assert their readiness to sign.

After being notified about that the acceptance of his proposed change to the terms, User-2 asserted his readiness to sign the document 36. The Negotiation Process Software sub-element 21recorded these events in the Security Log 37 and notified all Parties that User-2 was ready to sign the document 36.

Upon receiving the notification that User-2 was ready to sign the document 36, User-1 asserted his readiness to sign the document 36. The Negotiation Process Software sub-element 21 recorded these events in the Security Log 37 and notified all Parties that User-1 was ready to sign the document 36. The Negotiation Process Software sub-element 21 calculated that the requirements for advancing to the Execution Stage 205 were met and notified all Parties that they may commence signing.

After being notified that signing could commence, User-2 signed the document 36. The Negotiation Process Software sub-element 21 recorded this event in the Security Log 37 and notified all Parties that User-2 signed the document 36.

After being notified that signing could commence, User-1 signed the document 36. The Negotiation Process Software sub-element 21 recorded this event in the Security Log 37 and notified all Parties that User-1 signed the document 36. The Negotiation Process Software sub-element 21 calculated that all Parties had signed the document 36 an enacted measures to prevent changes to the contents of the unique private virtual space 35. The Negotiation Process Software sub-element 21 recorded these events in the Security Log 37, and notified all Parties that the document 36 had been successfully executed.

The Negotiation Process Software sub-element 21 calculated that the requirements for advancing to the Closed Stage 206 were met and provided all Parties with information they would need to obtain fully signed copies of the document 36 and information they would need to review the events that occurred during the electronic negotiation. The Negotiation Process Software sub-element recorded these events in the Security Log 37.

Acting on the information concerning fully signed copies of the document 36 User-1 obtained a fully signed copy of the document 36. Acting on similar information User-2 also obtained a fully signed copy of the document 36. The Negotiation Process Software sub-element calculated that the electronic negotiation process completed, and recorded these events in the Security Log 37.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

1. A process for creating a system for enabling the electronic negotiation of a binding agreement between a set of party users, comprising:
providing an enabled electronic network for communication between participating parties negotiating an agreement;
arranging a computer server having a plurality of discrete software elements for serially initiating, conducting, concluding or terminating participation in the negotiation of the binding agreement, and connecting participating parties to the electronic network, wherein the initiating element comprises a negotiating process sub-element, wherein the negotiating process sub-element uses an identity-source to authenticate a user prior to system interaction, and wherein the negotiating process sub-element uses a database sub-element to construct and maintain a field of user information describing the parties and users to the negotiation, and wherein the negotiating process sub-element uses a trusted identity sub-element in conjunction with user information to prevent a non-user access to the negotiating, and wherein the negotiating process sub-element uses a crypto key sub-element to protect the user information from a non-user, and wherein the negotiating process sub-element uses a database sub-element to create and maintain a virtual space for each negotiation and storage of its negotiation information, and wherein the negotiating process sub-element uses the database sub-element to create and maintain a security log to record events and activities during an electronic negotiation.

2. The process for creating a system for enabling the electronic negotiation of a binding agreement between a set of party users as recited in claim 1, including:
initiating, by a user, the negotiating process sub-element, to identify and issue secure invitations to other potential users to join the new electronic negotiation.

3. The process for creating a system for enabling the electronic negotiation of a binding agreement between a set of party users as recited in claim 2, including:
entering a registration process by an invited user, to interact with the negotiation process sub-element, so as to become an enrolled user upon successful completion of the registration process.

4. The process for creating a system for enabling the electronic negotiation of a binding agreement between a set of party users as recited in claim 3, including:
asserting to the negotiation process sub-element by the invited user, that the invited user is authorized to sign on behalf of their party.

5. The process for creating a system for enabling the electronic negotiation of a binding agreement between a set of party users as recited in claim 1, wherein the process includes six stages which consist of: a creation stage, an enrollment stage, a content consensus stage, a signing consensus stage, an execution stage and a closed stage.

6. The process for creating a system for enabling the electronic negotiation of a binding agreement between a set of party users as recited in claim 5, wherein the creation stage is initiated by participating users by keeping the users informed by the negotiation process sub-element through the network and the enrollment stage brings the parties together at the start of the electronic negotiations.

7. The process for creating a system for enabling the electronic negotiation of a binding agreement between a set of party users as recited in claim 6, wherein the content consensus stage enables the parties to add documents to a virtual private space and a mechanism to reach agreement on the terms of those documents.

8. The process for creating a system for enabling the electronic negotiation of a binding agreement between a set of party users as recited in claim 7, wherein the signing consensus stage provides the parties with a mechanism to indicate their readiness to sign the documents in the virtual private space.

9. The process for creating a system for enabling the electronic negotiation of a binding agreement between a set of party users as recited in claim 8, wherein the execution stage provides the parties with a mechanism to sign the documents contained in the virtual private space and contains mechanism to protect the contents contained in the virtual private space after all the parties have signed their respective documents.

10. A process for enabling the electronic negotiation of a binding agreement between a set of party users, wherein the process comprises:
arranging a computer server to be connected via a secure channel network, to a user;
installing a software element to be maintained by the server, which software element includes a negotiating process sub-element, wherein the negotiation process sub-element is arranged to regulate progression of the negotiation through six stages of the electronic negotiation process;
permitting the negotiating process sub-element to be utilized by an initiating user party to initiate an offer to a further party to become a user in the electronic negotiation process via a secure invitation;
constructing a unique instance of negotiation information and recording an accepting user party information in a unique virtual private space as a registered user;
documenting changes of the user parties and providing such documentation to any registered user in the virtual private space of the system;
reaching a stage wherein there are no further active changes to the documents in the virtual private space,
automatically incorporating changes into the document in the virtual private space in the consensus stage when at least one user from a different party accepts those changes;
signing off on the document in the virtual private space when a user of each party agrees to their readiness to sign the agreement; and
making available to each party by the negotiation process element, a copy of the signed document agreed to by each respective party.

11. The process for enabling the electronic negotiation of a binding agreement between a set of party users as recited in claim 10, wherein a party that has failed to sign the document in the unique private space may un-enroll from an electronic negotiation, and thus become a non-party.

12. The process for enabling the electronic negotiation of a binding agreement between a set of party users as recited in claim 11, wherein a user who has failed to sign the documents contained in the virtual private space changes the documents maintained in the virtual private space, and wherein the negotiation process then reverts back to a content consensus stage.

13. The process for enabling the electronic negotiation of a binding agreement between a set of party users as recited in claim 12, wherein a consensus stage is configured to restrict the number of documents that be added to an electronic negotiation.

14. The process for enabling the electronic negotiation of a binding agreement between a set of party users as recited in claim 13, wherein the consensus stage is configured to limit the number of users that are allowed to add documents to the unique virtual private space.

15. The process for enabling the electronic negotiation of a binding agreement between a set of party users as recited in claim 13, wherein the consensus stage is configured to require that a proposed change to a document be unanimously accepted by all users associated with other parties before it is incorporated into the document.

16. The process for enabling the electronic negotiation of a binding agreement between a set of party users as recited in claim 13, wherein the consensus stage has expiration conditions to a proposed change to be automatically withdrawn if it has failed to be accepted by a specific date and time period.

17. The process for enabling the electronic negotiation of a binding agreement between a set of party users as recited in claim 13, wherein the consensus stage is configured to disallow the addition or deletion of documents in the unique virtual private space.

18. The process for enabling the electronic negotiation of a binding agreement between a set of party users as recited in claim 13, wherein is configured to disallow proposed changes to documents in the unique virtual private space.

19. The process for enabling the electronic negotiation of a binding agreement between a set of party users as recited in claim 13, wherein the electronic negotiation is automatically voided if the negotiation process is incomplete by a date certain.

20. The process for enabling the electronic negotiation of a binding agreement between a set of party users as recited in claim 10, wherein negation process sub-element uses mechanisms of a trusted identity source sub-element to authenticate and authorize users in the electronic negotiation, and wherein the negotiation process sub-element uses the trusted identity source sub-element to catalogue and maintain user identity and credentials, and wherein the negotiation process sub-element uses the mechanisms and resources of a database sun-element to store information related to electronic negotiations and resulting agreements, and wherein the negotiation process sub-element uses the mechanisms of a crypto-key sub-element to digitally protect information stored in the database sub-element from disclosure to non-parties, and wherein the negotiation process sub-element uses the mechanisms and resources to digitally protect any event and activity information recorded in a system security log.
